(19) United States
(12) Patent Application Publication
(10) Pub. No.: US 2023/0259848 A1
(43) Pub. Date: Aug. 17, 2023

(54) METHOD AND DEVICE FOR RATIONAL ALLOCATION OF REGIONAL MULTI-SOURCE WATER RESOURCES DRIVEN BY BILATERAL CLASSIFIED WATER PRICES

(71) Applicant: Zhejiang Institute of Hydraulics & Estuary, Hangzhou (CN)

(72) Inventors: Shiwu WANG, Hangzhou (CN); Lei FU, Hangzhou (CN); Hongxi PENG, Hangzhou (CN); Jiancong WEN, Hangzhou (CN)

(21) Appl. No.: 18/109,984

(22) Filed: Feb. 15, 2023

(30) Foreign Application Priority Data
Feb. 16, 2022 (CN) 202210140924.6

(51) Int. Cl. G06Q 10/0631; G06Q 50/06; G06Q 10/04

(52) U.S. Cl. CPC G06Q 10/06315; G06Q 50/06; G06Q 10/04

(57) ABSTRACT

Disclosed are a method and a device for a rational allocation of regional multi-source water resources driven by bilateral classified water prices, belonging to the field of water resources management. The method establishes a supply-side and demand-side classified water price model based on a regional comprehensive water price by using a full-cost water price theory, solves the classified water price model and an established regional multi-source water resource allocation model driven by expected classified water prices of the supply-side and the demand-side by adopting a cooperative game method to obtain regional multi-source water resource allocation results, and the regional multi-source water resource allocation results include a water resource allocation strategy corresponding to the expected classified water prices of the supply-side and the demand-side.

### CROSS-REFERENCE TO RELATED APPLICATIONS

This application claims priority to Chinese Patent Application No. 202210140924.6, filed on Feb. 16, 2022, the contents of which are hereby incorporated by reference.

### TECHNICAL FIELD

The application belongs to the field of water resources management, and particularly relates to a method and a device for a rational allocation of regional multi-source water resources driven by bilateral classified water prices.

### BACKGROUND

In recent years, with a continuous promotion of an ecological civilization construction and a factor market allocation, it has become an effective way to solve regional water problems to carry out a rational allocation of multi-source water resources, including an optimal use of high quality water and a reclaimed water use.

Current water supply prices in China are priced according to principles of cost compensation and reasonable profit, while reclaimed water prices are priced by supply and demand sides through consultation. This policy has limitations in promoting the rational allocation of regional multi-source water resources as follows: for a specific region, different water production processes and water purification technologies are needed for different types of water sources because of different water quality, and corresponding engineering construction and operation management costs are also quite different. The better the water quality of the water source, the lower the construction and operation costs, the lower the approved water price, and the easier for consumers to accept the water price. On the contrary, the worse the water quality of the water source, the higher the construction and operation costs and the higher the water price, so it is more difficult for consumers to accept the water price. As a result, it is difficult to achieve a high quality and a good price because of insufficient stimuli for reclaimed water in a regional multi-source water resource allocation.

A price mechanism is a core part of a market mechanism, and a classified water price system is a key to drive a market-oriented allocation of the multi-source water resources. A multi-source water supply system in a certain region is taken as a whole, the rational allocation and an efficient utilization of the regional multi-source water resources are driven by the classified water price system on a supply-side and a user-side, and a regional water security guarantee ability is improved from aspects of water supply and demand balance and water ecological environment improvement.

### SUMMARY

An objective of embodiments of the application is to provide a method and a device for a rational allocation of regional multi-source water resources driven by bilateral classified water prices, so as to solve a problem of a high quality and a good price and an insufficient power for a reclaimed water use in a joint allocation of the regional multi-source water resources and multi-consumers. On a premise that the multi-source water resources may be rationally allocated and efficiently utilized, a regional water security guarantee ability is stronger and a water resources support ability is greater.

According to a first aspect of the embodiments of the application, provided is a method for a rational allocation of regional multi-source water resources driven by bilateral classified water prices, including following steps:

establishing a supply-side and demand-side classified water price model based on a regional comprehensive water price by using a full-cost water price theory;

solving the supply-side and demand-side classified water price model by adopting a cooperative game method to obtain expected classified water prices of the supply-side and the demand-side under a preset allocation scenario of the multi-source water resources;

obtaining expected comprehensive benefits and expected regional comprehensive water prices under different allocation scenarios of the multi-source water resources by using a weighted average method according to the expected classified water prices of the supply-side and the demand-side and a water supply capacity of the multi-source water resources;

establishing a regional multi-source water resource allocation model, where the regional multi-source water resource allocation model at least meets following constraints: a weighted average water price of the multi-source water resources for the multi-consumers is not lower than the expected regional comprehensive water price, a river and lake ecological environment control section is not worse than a target water quality, the expected comprehensive benefits of the multi-source water resource allocation are maximized, and a water availability is constrained, and regional multi-source water resource allocation results include a water resource allocation strategy corresponding to the expected classified water prices of the supply-side and the demand-side; and

solving the established regional multi-source water resource allocation model by using the cooperative game method to obtain the regional multi-source water resource allocation results.

In an embodiment, establishing the supply-side and demand-side classified water price model based on the regional comprehensive water price includes:

for a regional multi-source water supply system with NI classes of water sources and NJ consumers, based on the regional comprehensive water price, a calculation model of the expected classified water prices of the supply-side and the demand-side is:

$$C = \frac{{\sum }_{i = 1}^{n} {Gc}_{i} \times {Q}_{i}}{{\sum }_{i = 1}^{n} {Q}_{i}} = \frac{{\sum }_{i = 1}^{n} {\sum }_{j = 1}^{m} {Gy}_{ij} \times {q}_{ij}}{{\sum }_{i = 1}^{n} {\sum }_{j = 1}^{m} {q}_{ij}} ,$$

where C is the regional comprehensive water price, consisting of a resource cost, an engineering cost, an environmental cost, a water supply profit rate and a tax of the regional multi-source water supply system;

Gcᵢ is an expected supply-side water price of a class i water source;

Gyᵢⱼ is a demand-side water price of the class i water source for class consumers;

Qᵢ is a water supply quantity of the class i water source allocation under a specific water resource allocation scenario; and

qᵢⱼ is an amount of water allocated by the class i water source to the class j consumers, and

$${Q}_{i} = {\sum }_{j = 1}^{m} {q}_{ij} .$$

In an embodiment, solving the supply-side and demand-side classified water price model by adopting the cooperative game method to obtain the expected classified water prices of the supply-side and the demand-side under the preset allocation scenario of the multi-source water resources including:

1) establishing a game strategy optimization model for supply-side multi-source water supply enterprises and demand-side consumers under a cooperative condition;

2) setting an initial value of a classified water price equilibrium point on the supply-side and the demand-side: randomly selecting the initial value of the classified water price equilibrium point from a strategy set of each decision variable as (P_{GC}⁰,P_{GY}⁰)=[(Gcᵢ⁰),(Gyᵢⱼ⁰), i=1, . . . , NI; j=1, . . . NJ];

3) making independent optimization decisions by game alliances of the supply-side and the demand-side respectively: obtaining an optimal strategy combination (P_{GC}ⁿ, P_{GY}ⁿ)=[(Gcᵢⁿ),(Gyᵢⱼⁿ), i=1, . . . , NI; j=1, . . . NJ] by each party of a game through an optimization algorithm according to an optimization result (P_{GC}ⁿ⁻¹, P_{GY}ⁿ⁻¹)=[(Gcᵢⁿ⁻¹),(Gyᵢⱼⁿ⁻¹), i=1, . . . , NI; j=1, . . . NJ] of a previous round of each party during an nth round of optimization, and

$${P}_{GC}^{n} = {arg max}_{{p}_{GC}} {W}_{GC} ( {P}_{GC} , {P}_{GC}^{n - 1} ) ; {P}_{GY}^{n} = {arg min}_{{P}_{GY}} {W}_{GY} ( {P}_{GY}^{n - 1} , {P}_{GY} ) ,$$

where W_{GC} and W_{GY} are a revenue function of the supply-side water supply enterprises and a payment function of the demand-side consumers respectively; and

4) if two successive optimal solutions obtained by each participant in the game are the same and (P_{GC}ⁿ⁻¹,P_{GY}ⁿ⁻¹)=(P_{GC}ⁿ,P_{GY}ⁿ)−(P_{GC}^{*},P_{GY}^{*}) considering that the game has reached a Nash equilibrium point under this strategy combination according to a Nash equilibrium definition, and ending the optimization, and obtaining expected equilibrium classified water prices of the supply-side and the demand-side under a specific allocation scenario of the multi-source water resources; otherwise, continuing the optimization.

In an embodiment, obtaining the expected comprehensive benefits and the expected regional comprehensive water prices under different allocation scenarios of the multi-source water resources by using the weighted average method including:

obtaining the expected comprehensive benefits under different allocation scenarios of the multi-source water resources by calculating differences between expected benefits and penalty benefits of a remaining water supply capacity after the multi-source water resource allocation, where the penalty benefits include a penalty benefit caused by an unsatisfied water consumption of the demand-side consumers and a penalty benefit caused by a below-standard water quality of the river and lake control section; and

calculating a weighted average of a regional multi-source allocation water quantity and a supply-side classified water price to obtain the expected regional comprehensive water price.

In an embodiment, the regional multi-source water resource allocation model is established, and the regional multi-source water resource allocation model at least meets the following constraints: the weighted average water price of the multi-source water resources for the multi-consumers is not lower than the expected regional comprehensive water price, the river and lake ecological environment control section is not worse than the target water quality, the expected comprehensive benefits of the multi-source water resource allocation are maximized, and the water availability is constrained:

1) an expected comprehensive benefit of the regional multi-source water resource allocation model is:

$$max {F}_{Qq} = {\sum }_{i = 1}^{NI} [ {Q}_{i}^{max} - {Q}_{i} ] \times {B}_{i} - {\sum }_{i = 1}^{NI} {\sum }_{j = 1}^{NJ} [ {QE}_{ij} \times {C}_{ij} + {f}_{1} ( {q}_{ij} ) ] ;$$

2) the constraint condition that the weighted average water price of the multi-source water resources for the multi-consumers is not lower than the regional comprehensive water price is:

$$\frac{{\sum }_{i = 1}^{NI} {Gc}_{i} \times {Q}_{i}}{{\sum }_{i = 1}^{NI} {Q}_{i}} = \frac{{\sum }_{i = 1}^{NI} {\sum }_{j = 1}^{NJ} {Gy}_{ij} \times {q}_{ij}}{{\sum }_{i = 1}^{NI} {\sum }_{j = 1}^{NJ} {q}_{ij}} \geq C ;$$

3) the constraint condition that the river and lake ecological environment control section is not worse than the target water quality is expressed as:

Qrₘ[f₂(qᵢⱼ)]≤Qrₘ^{*}; and

4) the constraint condition of the water availability is expressed as:

Qᵢ≤Qᵢ^{max},

where F_{Qq} is the expected comprehensive benefit of the regional multi-source water resource allocation;

Qᵢ^{max} is a maximum water supply capacity of the class i water source;

Qᵢ is a water supply quantity of the class i water source allocation;

Bᵢ is a net benefit per cubic meter of water of the class i water source;

QEᵢⱼ is a water shortage allocated by the class i water source to the class j consumers;

Cᵢⱼ is a penalty benefit of the water shortage per unit allocated by the class i water source to the class j consumers;

qᵢⱼ is an amount of water allocated by the class i water source to the class j consumers;

f₁(qᵢⱼ) is a penalty benefit of the river and lake ecological environment control section when the amount of water allocated by the class i water source to the class j consumers is qᵢⱼ;

Gcᵢ is a supply-side water price of the class i water source;

Gyᵢⱼ is a demand-side water price of the class i water source for the class j consumers;

C is the regional comprehensive water price;

Qrₘ└f₂(qᵢⱼ)┘ is a water quality of a mth river and lake ecological environment control section when the amount of water allocated by the class i water source to the class j consumers is qᵢⱼ; and

Qrₘ^{*} is a target water quality of the mth river and lake ecological environment control section when the amount of water allocated by the class i water source to the class j consumers is qᵢⱼ.

In an embodiment, solving the established regional multi-source water resource allocation model by using the cooperative game method to obtain the regional multi-source water resource allocation results, including:

1) establishing a game strategy optimization model of the regional multi-source water resource allocation model based on expected equilibrium classified water prices of the supply-side and the demand-side under the specific allocation scenario of the multi-source water resources;

2) setting an initial value of an equilibrium point of a multi-source water resource allocation strategy: randomly selecting the initial value of the equilibrium point of the multi-source water resource allocation strategy from a strategy set of each decision variable as Q_{q}⁰=(qᵢⱼ⁰, i=1, . . . , NI; j=1, . . . NJ);

3) making optimization decisions by the game alliances: in an nth round of optimization, obtaining an optimal strategy combination Qqⁿ=(qᵢⱼⁿ, i=1, . . . , NI; j=1, . . . NJ) through the optimization algorithm according to an optimization result of the previous round of Qqⁿ⁻¹=(qᵢⱼⁿ⁻¹, i=1, . . . NI; j=1, . . . NJ), and

$${Qq}^{n} = {arg max}_{Qq} {F}_{Qq} ( Qq , {Qq}^{n - 1} ) ,$$

where F_{Qq} is the expected comprehensive benefit of the regional multi-source water resource allocation model; and

4) if the two successive optimal solutions obtained by each participant in the game are the same and Qqⁿ⁻¹=Qqⁿ=Qq^{*}, considering that the game has reached the Nash equilibrium point under this strategy combination according to the Nash equilibrium definition, and ending the optimization; otherwise, continuing the optimization.

According to a second aspect of the embodiments of the application, there is provided a device for a rational allocation of regional multi-source water resources driven by bilateral classified water prices, including:

a first model establishment module used for establishing the supply-side and demand-side classified water price model based on the regional comprehensive water price by using the full-cost water price theory;

a first solving module used for solving the supply-side and demand-side classified water price model by adopting the cooperative game method to obtain the expected classified water prices of the supply-side and the demand-side under the preset allocation scenario of the multi-source water resources;

a calculation module used for obtaining the expected comprehensive benefits and the expected regional comprehensive water prices under different allocation scenarios of the multi-source water resources by using the weighted average method according to the expected classified water prices of the supply-side and the demand-side and the water supply capacity of the multi-source water resources;

a second model establishment module used for establishing the regional multi-source water resource allocation model, wherein the regional multi-source water resource allocation model at least meets the following constraints: the weighted average water price of the multi-source water resources for multi-consumers is not lower than the expected regional comprehensive water price, the river and lake ecological environment control section is not worse than the target water quality, the expected comprehensive benefits of the multi-source water resource allocation are maximized, and the water availability is constrained, and the regional multi-source water resource allocation results include the water resource allocation strategy corresponding to the expected classified water prices of the supply-side and the demand-side; and

a second solving module used for solving the established regional multi-source water resource allocation model by using the cooperative game method to obtain the regional multi-source water resource allocation results.

According to a third aspect of the embodiments of the present application, there is provided an electronic device, including:

one or more processors; and

a memory for storing one or more programs;

when the one or more programs are executed by the one or more processors, the one or more processors implement a method as described in the first aspect.

According to a fourth aspect of the embodiments of the present application, a computer-readable storage medium having computer instructions stored thereon is provided, wherein the instructions implement the steps of the method as described in the first aspect.

A technical scheme provided by the embodiments of the application may include following beneficial effects.

As may be seen from the above embodiments, according to the application, the regional multi-source water resources including the reclaimed water are regarded as a whole, the supply-side and demand-side classified water price model is established based on the regional comprehensive water price by adopting the full-cost water price theory, and the supply-side and demand-side classified water price model is solved by adopting a cooperative game model to obtain the expected classified water prices of the supply-side and the demand-side under the specific allocation scenario of the multi-source water resources; further, the expected classified water prices of the supply-side and the demand-side under the specific allocation scenario of the multi-source water resources are obtained, and the regional multi-source water resource allocation model driven by the expected classified water prices of the supply-side and the demand-side is established; the regional multi-source water resource allocation model at least meets the following constraints: the weighted average water price of the multi-source water resources is not lower than the expected regional comprehensive water price, the river and lake ecological environment control section is not worse than the target water quality, the expected comprehensive benefits of the multi-source water resource allocation are maximized, and the water availability is constrained; an immune particle swarm optimization algorithm is used to solve the regional multi-source water resource allocation model, so that a classified water price system may effectively drive a rational allocation of the multi-source water resources including an optimal water use of high quality water and the reclaimed water use, and promote the multi-source water resource allocation to be more reasonable and efficient.

It is to be understood that both a foregoing general description and a following detailed description are exemplary and explanatory only and are not restrictive of the present application.

### BRIEF DESCRIPTION OF THE DRAWINGS

Accompanying drawings herein are incorporated into a specification and constitute a part of this specification, showing embodiments in accordance with the application, and are used together with the specification to explain principles of the application.

FIG. 1 is a flow chart of a method for a rational allocation of regional multi-source water resources driven by bilateral classified water prices according to an exemplary embodiment.

FIG. 2 is a block diagram of a device for a rational allocation of regional multi-source water resources driven by bilateral classified water prices according to an exemplary embodiment.

### DETAILED DESCRIPTION OF THE EMBODIMENTS

Exemplary embodiments may be described in detail here, and examples thereof are illustrated in accompanying drawings. When the following description refers to the drawings, unless otherwise indicated, the same numbers in different drawings indicate the same or similar elements. The embodiments described in the following exemplary embodiments do not represent all embodiments consistent with this application. Rather, the embodiments are merely examples of devices and methods consistent with some aspects of the present application as detailed in appended claims.

Terminology used in this application is for an objective of describing specific embodiments only and is not intended to limit this application. Singular forms “a”, “the” and “this” used in this application and the appended claims are also intended to include the plural forms, unless a context clearly indicates other meaning. It should also be understood that a term “and/or” as used herein refers to and includes any or all possible combinations of one or more associated listed items.

It should be understood that although the terms first, second, third, etc. may be used in this application to describe various information, the information should not be limited to these terms. These terms are only used to distinguish the same type of information from each other. For example, without departing from a scope of this application, the first information may also be called the second information, and similarly, the second information may also be called the first information. Depending on the context, the word “if” as used herein may be interpreted as “when” or “at the time” or “in response to a determination”.

Before introducing this embodiment, in order to make the embodiments of the application clearer, here is a brief introduction to a full-cost water price theory.

The full-cost water price theory is a basic theory used to approve a water supply price. A full-cost refers to a total cost of a whole process including water source, water intake, water delivery, water purification, water distribution, water use, sewage treatment and drainage, etc. A full-cost water price is the water supply price that consumers should pay for using water resources, consisting of a resource cost, an engineering cost, an environmental cost, a water supply profit and a tax. This theory has limitations in a joint allocation of regional multi-source water resources as follows: different water production processes and technologies are needed for different types of water sources because of different water quality, and corresponding engineering construction and operation management costs are also quite different. The better the water quality of the water source, the lower the water supply cost, the lower the approved water price, and the easier it is for the consumers to choose the water source. On the contrary, the worse the water quality of the water source, the higher the water supply cost and the higher the approved water price, so it is consequently more difficult for the consumers to accept the water price. The limitations affect a rational allocation and an efficient utilization of the water resources. In order to solve this problem, the application takes the regional multi-source water resources as a whole, and adopts the full-cost water price theory to approve a regional comprehensive water price, so as to ensure a sustainable development of a regional water supply industry.

After the regional comprehensive water price is approved, a supply-side and demand-side classified water price model based on the regional comprehensive water price are established, with an objective of pricing supply-side and demand-side classified water prices of the multi-source water resources respectively, so as to keep a reasonable price comparison relationship between the supply-side classified water price and the demand-side classified water price of the multi-source water resources, and promote an optimal use of high quality water and a reclaimed water use.

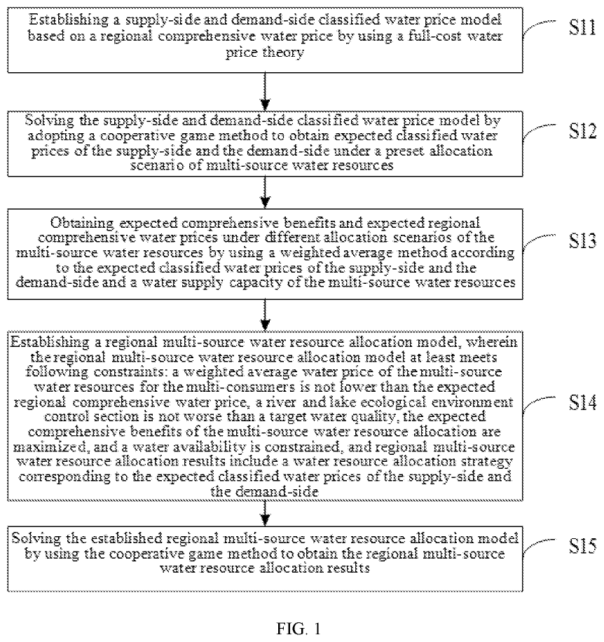

FIG. 1 is a flowchart of a method for a rational allocation of regional multi-source water resources driven by bilateral classified water prices according to an exemplary embodiment. As shown in FIG. 1, the method may include following steps:

S11, establishing the supply-side and demand-side classified water price model based on the regional comprehensive water price by using the full-cost water price theory;

S12, solving the supply-side and demand-side classified water price model by adopting a cooperative game method to obtain expected classified water prices of the supply-side and the demand-side under a preset allocation scenario of the multi-source water resources;

S13, obtaining expected comprehensive benefits and expected regional comprehensive water prices under different allocation scenarios of the multi-source water resources by using a weighted average method according to the expected classified water prices of the supply-side and the demand-side and a water supply capacity of the multi-source water resources;

S14, establishing a regional multi-source water resource allocation model, where the regional multi-source water resource allocation model at least meets following constraints: a weighted average water price of the multi-source water resources for the multi-consumers is not lower than the expected regional comprehensive water price, a river and lake ecological environment control section is not worse than a target water quality, the expected comprehensive benefits of the multi-source water resource allocation are maximized, and a water availability is constrained, and regional multi-source water resource allocation results include a water resource allocation strategy corresponding to the expected classified water prices of the supply-side and the demand-side; and

S15, solving the established regional multi-source water resource allocation model by using the cooperative game method to obtain the regional multi-source water resource allocation results.

As may be seen from the above embodiments, according to the application, the regional multi-source water resources including the reclaimed water are regarded as as a whole, the supply-side and demand-side classified water price model is established based on the regional comprehensive water price by adopting the full-cost water price theory, and the supply-side and demand-side classified water price model is solved by adopting a cooperative game model to obtain the expected classified water prices of the supply-side and the demand-side under a specific allocation scenario of the multi-source water resources; further, the expected classified water prices of the supply-side and the demand-side under the specific allocation scenario of the multi-source water resources are obtained, and the regional multi-source water resource allocation model driven by the expected classified water prices of the supply-side and the demand-side is established; the regional multi-source water resource allocation model at least meets the following constraints: the weighted average water price of the multi-source water resources is not lower than the expected regional comprehensive water price, the river and lake ecological environment control section is not worse than the target water quality, the expected comprehensive benefits of the multi-source water resource allocation are maximized, and the water availability is constrained; the cooperative game method is used to solve the regional multi-source water resource allocation model, so that a classified water price system may effectively drive the rational allocation of the multi-source water resources including the optimal water use of the high quality water and the reclaimed water use, and promote the multi-source water resource allocation to be more reasonable and efficient.

In a specific implementation of the S11, the supply-side and demand-side classified water price model based on the regional comprehensive water price is established by using the full-cost water price theory.

Specifically, for a regional water resources system with NI classes of water sources, a regional comprehensive water price model based on full-cost accounting is established as follows:

$$C = \frac{{\sum }_{i = 1}^{n} ( {R}_{i} + {P}_{i} + {E}_{i} ) \times ( 1 + r + δ ) \times {Q}_{i}}{{\sum }_{i = 1}^{n} {Q}_{i}} \\ {F}_{i} = ( {R}_{i} + {P}_{i} + {E}_{i} ) \times ( 1 + r + δ )$$

where C is the regional comprehensive water price;

Rᵢ is the resource cost of a class i water source, where i=1, . . . , NI;

Pᵢ is the project cost of the class i water source, where i=1, . . . , NI;

Eᵢ is the resource cost of the class i water source, where i=1, . . . , NI;

r and δ are a water supply profit rate and the tax, respectively, in accordance with relevant provisions of the state;

Fᵢ is the full-cost water price of the class i water source, where i=1, . . . , NI;

Qᵢ is an expected water supply quantity of the class i water source under a specific water resource allocation scenario (or target).

For the regional water resources system with the NI classes of water sources and NJ consumers, based on the regional comprehensive water price, an expected classified water price model of the supply-side and the demand-side is established as follows:

$$C = \frac{{\sum }_{i = 1}^{NI} {Gc}_{i} \times {Q}_{i}}{{\sum }_{i = 1}^{NI} {Q}_{i}} = \frac{{\sum }_{i = 1}^{NI} {\sum }_{j = 1}^{NJ} {Gy}_{ij} \times {q}_{ij}}{{\sum }_{i = 1}^{NI} {\sum }_{j = 1}^{NJ} {q}_{ij}} ,$$

where Gcᵢ is an expected supply-side water price of the class i water source;

Gyᵢⱼ is an expected demand-side water price of the class i water source for the class j consumers; and

qᵢⱼ is an expected water consumption of the class j consumers of the class i water source, and

$${Q}_{i} = {\sum }_{j = 1}^{NJ} {q}_{ij} .$$

An expected implementation water price model of the NI classes of water sources is as follows:

$${c}_{i} = ( {F}_{i} \times {Q}_{i} \times C ) / [ {\sum }_{i = 1}^{NI} ( {F}_{i} \times {Q}_{i} ) ] ,$$

where cᵢ is the expected implementation water price of the class i water source.

In a specific implementation of the S12, solving the supply-side and demand-side classified water price model by adopting the cooperative game method to obtain the expected classified water prices of the supply-side and the demand-side under the preset allocation scenario of the multi-source water resources including following sub-steps.

1) A game strategy optimization model for supply-side multi-source water supply enterprises and the demand-side consumers is established under a cooperative condition.

Specifically, the supply-side multi-source water supply enterprises and the demand-side consumers are respectively regarded as cooperative game participants. The participants of the supply-side and the demand-side are represented by W_{GC} and W_{GY} respectively. When W_{GC} and W_{GY} play games respectively, game strategies are that the water prices on the supply-side and the demand-side are Gcᵢ(i=1 . . . NI) and Gyᵢⱼ=1, . . . , NI; j=1, . . . , NJ) respectively. The following is the game strategy optimization model of the supply-side multi-source water supply enterprises and the demand-side consumers in under the cooperative condition:

participants: supply-side {W_{GC}}, demand-side {W_{GY}};

strategy sets: (P_{GC}, P_{GY})=[(Gcᵢ),(Gyᵢⱼ), i=1, . . . , NI; j=1, . . . NJ], Gcᵢ=[Gcᵢ^{min},Gcᵢ^{max}], and Gyᵢⱼ=[Gyᵢⱼ^{min},Gyᵢⱼ^{max}]; and

information sets: multi-source water supply capacity, consumer demand, water price tolerance of consumers, and water resources allocation engineering capacity.

Supply-side revenue function:

$${W}_{GC} = {\sum }_{i = 1}^{NI} [ {Gc}_{i} \times {Q}_{i} ] \geq C \times {\sum }_{i = 1}^{NI} {Q}_{i} ,$$

demand-side payment function:

$${W}_{GY} = {\sum }_{i = 1}^{NI} {\sum }_{j = 1}^{NJ} [ {Gy}_{ij} \times {q}_{ij} ] \geq C \times {\sum }_{i = 1}^{NI} {Q}_{i} ,$$

where Gcᵢ^{min}, Gcᵢ^{max} are a lower limit and an upper limit of the expected supply-side water price of the class i water source;

Gyᵢⱼ^{min},Gyᵢⱼ^{max} are a lower limit and an upper limit of the expected demand-side water price of the class i water source for the class j consumers; and

W_{GC} and W_{GY} are the revenue function of the supply-side water supplier and the payment function of the demand-side consumers respectively, and are equal in value.

2) An initial value of a classified water price equilibrium point of the supply-side and the demand-side is set: the initial value of the classified water price equilibrium point is randomly selected from the strategy set of each decision variable as (P_{GC}⁰,P_{GY}⁰)=[(Gcᵢ⁰),(Gyᵢⱼ⁰), i=1, . . . , NI; j=1, . . . NJ];

specifically, it is required that the initial value of the classified water price equilibrium point of the supply-side and the demand-side should be in the strategy set, and) (Gcᵢ⁰)∈(Gcᵢ), i=1, . . . , NI, (Gyᵢⱼ⁰)∈(Gyᵢⱼ), i=1, . . . , NI, j=1, . . . , NJ.

3) Game alliances of the supply-side and the demand-side make independent optimization decisions respectively: with a goal that the supply-side revenue function and the demand-side payment function are greater than or equal to the expected regional comprehensive water price, each party of the game obtains an optimal strategy combination (P_{GC}ⁿ,P_{GY}ⁿ)=[(Gcᵢⁿ),(Gyᵢⱼⁿ), i=1, . . . NI; j=1, . . . NJ] through an optimization algorithm according to optimization result (P_{GC}ⁿ⁻¹,P_{GY}ⁿ⁻¹)=[(Gcᵢⁿ⁻¹),(Gyᵢⱼⁿ⁻¹), i=1, . . . , NI; j=1, . . . NJ] of the previous round of each party during an nth round of optimization, and

$${P}_{GC}^{n} = {arg max}_{{p}_{GC}} {W}_{GC} ( {P}_{GC} , {P}_{GC}^{n - 1} ) , {P}_{GY}^{n} = {arg min}_{{P}_{GY}} {W}_{GY} ( {P}_{GY}^{n - 1} , {P}_{GY} ) ,$$

where W_{GC} and W_{GY} are the revenue function of the supply-side water supply enterprises and the payment function of the demand-side consumers respectively.

Specifically, the optimization is performed from the supply-side and the demand-side respectively to obtain an optimal strategy of one's own side under a condition that an other side of the game chooses the optimal strategy; the supply-side revenue function and the demand-side payment function are calculated, and whether the functions are greater than or equal to the expected regional comprehensive water price is judged; if this requirement is met, the next step is performed; otherwise, the next round of optimization is performed.

4) If two successive optimal solutions obtained by each participant in the game are the same and (P_{GC}ⁿ⁻¹, P_{GY}ⁿ⁻¹)=(P_{GC}ⁿ, P_{GY}ⁿ)=(P_{GC}^{*},P_{GY}^{*}), it is considered that the game has reached a Nash equilibrium point under this strategy combination according to a Nash equilibrium definition, and the optimization is over, and expected equilibrium classified water prices of the supply-side and the demand-side under the specific allocation scenario of the multi-source water resources are obtained; otherwise, the optimization continues.

Specifically, if there is a Nash equilibrium point in the above-mentioned cooperative game model, according to the Nash equilibrium definition, the Nash equilibrium point should satisfy:

$${P}_{GC}^{*} = {arg max}_{{P}_{GC}} {W}_{GC} ( {P}_{GC} , {P}_{GC}^{*} ) \\ {P}_{GY}^{*} = {arg min}_{{P}_{GY}} {W}_{GY} ( {P}_{GY}^{*} , {P}_{GY} ) .$$

In the above formula, P_{GC}^{*} and P_{GY}^{*} represent the optimal strategy of one's own side under the condition that the other side of the game chooses the optimal strategy from the supply-side and the demand-side respectively. Given the information, a water price combination strategy may achieve a multi-source water resource multi-consumer water price equilibrium in a sense of Nash equilibrium from the supply-side and the demand-side respectively.

For the above-mentioned cooperative game optimization problem, the Nash equilibrium point is solved by an iterative search method. According to the iterative search method, firstly, iterative decision variables are determined, and the iterative decision variables according to the application are the classified water prices of the supply-side and the demand side respectively; secondly, an iterative relationship is established, and a next decision variable value is solved from an initial decision variable value according to the iterative relationship; and finally, the Nash equilibrium point is determined according to the water price combination strategy when the revenue function and the payment function of the model are optimal.

A specific solution process of the cooperative game optimization problem includes following solution steps:

S1: inputting original data and parameters, and initializing the data, including relevant parameters and data such as multi-source water supply capacity, consumer demand, water price tolerance of consumers, and engineering capacity, etc.;

S2: establishing a game strategy model of the supply-side multi-source water supply enterprises and the demand-side consumers under the cooperative condition;

S3: setting the initial value of the classified water price equilibrium point of the supply-side and the demand-side: randomly selecting the initial value of the classified water price equilibrium point from the strategy set of each decision variable as (P_{GC}⁰,P_{GY}⁰)=[(Gcᵢ⁰),(Gyᵢⱼ⁰), i=1, . . . , NI; j=1, . . . NJ];

S4: making the independent optimization decisions by the game alliances of the supply-side and the demand-side respectively: obtaining the optimal strategy combination (P_{GC}ⁿ,P_{GY}ⁿ)=[(Gcᵢⁿ),(Gyᵢⱼⁿ), i=1, . . . NI; j=1, . . . NJ] by each party of the game through the optimization algorithm according to the optimization result (P_{GC}ⁿ⁻¹,P_{GY}ⁿ⁻¹)=[(Gcᵢⁿ⁻¹),(Gyᵢⱼⁿ⁻¹), i=1, . . . , NI; j=1, . . . NJ] of the previous round of each party during the nth round of optimization, and

$${P}_{GC}^{n} = {arg max}_{{p}_{GC}} {W}_{GC} ( {P}_{GC} , {P}_{GC}^{n - 1} ) , {P}_{GY}^{n} = {arg min}_{{P}_{GY}} {W}_{GY} ( {P}_{GY}^{n - 1} , {P}_{GY} ) ;$$

where W_{GC} and W_{GY} are the revenue function of the supply-side water supply enterprises and the payment function of the demand-side consumers respectively;

S5: calculating the supply-side revenue function and the demand-side payment function;

S6: if the two successive optimal solutions obtained by each participant in the game are the same and (P_{GC}ⁿ⁻¹,P_{GY}ⁿ⁻¹)=(P_{GC}ⁿ,P_{GY}ⁿ)=(P_{GC}^{*},P_{GY}^{*}), considering that the game has reached the Nash equilibrium point under this strategy combination according to the Nash equilibrium definition; proceeding to S7 if the equilibrium point is found, and outputting results; and returning to the S4 if the equilibrium point is not reached; and

S7: obtaining the optimal strategy combination of the supply-side and demand-side classified water prices. Considering an influence of the initial value on the solution of the equilibrium point, the initial value may be re-selected in the S3 if the algorithm does not converge.

In the specific implementation of the S13, obtaining the expected comprehensive benefits and the expected regional comprehensive water prices under different allocation scenarios of the multi-source water resources by using the weighted average method according to the expected classified water prices of the supply-side and the demand-side and the water supply capacity of the multi-source water resources including following specific steps:

S1, obtaining the expected comprehensive benefits under different allocation scenarios of the multi-source water resources by calculating differences between expected benefits and penalty benefits of a remaining water supply capacity after the multi-source water resource allocation, where the penalty benefits include a penalty benefit caused by an unsatisfied water consumption of the demand-side consumers and a penalty benefit caused by a below-standard water quality of the river and lake control section;

specifically, approving a net benefit per cubic meter of water of the multi-source water resources, a penalty benefit of a water shortage of the consumers and a penalty benefit of the river and lake ecological environment control section respectively, where the expected comprehensive benefits obtained under different allocation scenarios of the multi-source water resources are the differences between the expected benefits and the penalty benefits of the remaining water supply capacity after the multi-water resources allocation; and

S2, calculating a weighted average of a regional multi-source allocation water quantity and the supply-side classified water price to obtain the expected regional comprehensive water price.

In the specific implementation of S14, the regional multi-source water resource allocation model is established, where the regional multi-source water resource allocation model at least meets the following constraints: the weighted average water price of the multi-source water resources for the multi-consumers is not lower than the expected regional comprehensive water price, the river and lake ecological environment control section is not worse than the target water quality, the expected comprehensive benefits of the multi-source water resource allocation are maximized, and the water availability is constrained, and the regional multi-source water resource allocation results include the water resource allocation strategy corresponding to the expected classified water prices of the supply-side and the demand-side: and the strategy specifically includes:

S1: obtaining an expected comprehensive benefit of the regional multi-source water resource allocation model as follows:

$$max {F}_{Qq} = {\sum }_{i = 1}^{NI} [ {Q}_{i}^{max} - {Q}_{i} ] \times {B}_{i} - {\sum }_{i = 1}^{NI} {\sum }_{j = 1}^{NJ} [ {QE}_{ij} \times {C}_{ij} + {f}_{1} ( {q}_{ij} ) ] ;$$

and

S2: obtaining the constraint conditions of the regional multi-source water resource allocation model:

1) the constraint condition that the weighted average water price of the multi-source water resources for the multi-consumers is not lower than the regional comprehensive water price is:

$$\frac{{\sum }_{i = 1}^{NI} {Gc}_{i} \times {Q}_{i}}{{\sum }_{i = 1}^{NI} {Q}_{i}} = \frac{{\sum }_{i = 1}^{NI} {\sum }_{j = 1}^{NJ} {Gy}_{ij} \times {q}_{ij}}{{\sum }_{i = 1}^{NI} {\sum }_{j = 1}^{NJ} {q}_{ij}} \geq C ;$$

2) the constraint condition that the river and lake ecological environment control section is not worse than the target water quality is expressed as:

Qrₘ[f₂(qᵢⱼ)]≤Qrₘ^{*}; and

3) the constraint condition of the water availability is expressed as:

Qᵢ≤Qᵢ^{max},

where F_{Qq} is the expected comprehensive benefit of the regional multi-source water resource allocation;

Qᵢ^{max} is a maximum water supply capacity of the class i water source;

Qᵢ is the water supply quantity of the class i water source allocation;

Bᵢ is a net benefit per cubic meter of water of the class i water source;

QEᵢⱼ is a water shortage allocated by the class i water source to the class j consumers;

Cᵢⱼ is a penalty benefit of the water shortage per unit allocated by the class i water source to the class j consumers;

qᵢⱼ is an amount of water allocated by the class i water source to the class j consumers;

f₁(qᵢⱼ) is a penalty benefit of the river and lake ecological environment control section when the amount of water allocated by the class i water source to the class j consumers is qᵢⱼ;

Gcᵢ is a supply-side water price of the class i water source;

Gyᵢⱼ is a demand-side water price of the class i water source for the class j consumers;

C is the regional comprehensive water price;

Qrₘ└f₂(qᵢⱼ)┘ is a water quality of a mth river and lake ecological environment control section when the amount of water allocated by the class i water source to the class j consumers is qᵢⱼ; and

Qrₘ^{*} is a target water quality of the mth river and lake ecological environment control section when the amount of water allocated by the class i water source to the class j consumers is qᵢⱼ.

In the specific implementation of the S15, the established regional multi-source water resource allocation model is solved by the cooperative game method, and the regional multi-source water resource allocation results are obtained.

The cooperative game method is used to solve the regional multi-source water resource allocation model. Specific steps are as follows:

S1, establishing a game strategy optimization model of the regional multi-source water resource allocation model based on the expected equilibrium classified water prices of the supply-side and the demand-side under the specific allocation scenario of the multi-source water resources:

participants: water supply side {WQᵢ}, consumer demand side {Wq};

strategy set: Qq=(qᵢⱼ, i=1, . . . , NI; j=1, . . . NJ) and

objective function: max F_{Qq};

S2: setting an initial value of an equilibrium point of a multi-source water resource allocation strategy: randomly selecting the initial value of the equilibrium point of the multi-source water resource allocation strategy from the strategy set of each decision variable as Qq⁰=(qᵢⱼ⁰, i=1, . . . , NI; j=1, . . . NJ);

S3: making the optimization decisions by the game alliances: in the nth round of optimization, obtaining an optimal strategy combination Qqⁿ=(qᵢⱼⁿ, i=1, . . . , NI; j=1, . . . NJ) through the optimization algorithm according to the optimization result of the previous round of Qqⁿ⁻¹=(qᵢⱼⁿ⁻¹, i=1, . . . , NI; j=1, . . . NJ), and

$${Qq}^{n} = {arg max}_{Qq} {F}_{Qq} ( Qq , {Qq}^{n - 1} ) ,$$

where F_{Qq} is the expected comprehensive benefit of the regional multi-source water resource allocation model; and

S4: if two successive optimal solutions obtained by each participant in the game are the same and Qqⁿ⁻¹=Qqⁿ=Qq*, considering that the game has reached the Nash equilibrium point under this strategy combination according to the Nash equilibrium definition, and ending the optimization; otherwise, continuing the optimization.

In this application, the supply-side and demand-side classified water price model based on the regional comprehensive water price is established by adopting the full-cost water price theory; according to the technical scheme that solves the classified water price model and the established regional multi-source water resource allocation model driven by the expected classified water prices of the supply-side and the demand-side by adopting the cooperative game method, the problems of the optimal water use of the high quality water and insufficient driving force for sewage recycling in the joint allocation of the regional multi-source water resources may be effectively solved, making the regional multi-source water resource allocation more reasonable and efficient.

Corresponding to the embodiments of the above-mentioned rational allocation method of the regional multi-source water resources driven by the bilateral classified water prices, the application also provides a device for a rational allocation of regional multi-source water resources driven by bilateral classified water prices.

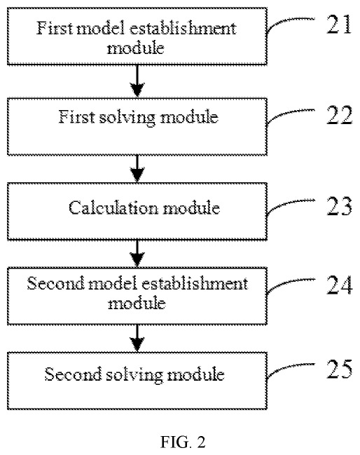

FIG. 2 is a block diagram of the device for the rational allocation of the regional multi-source water resources driven by the bilateral classified water prices according to one exemplary embodiment. With reference to FIG. 2, the device includes:

a first model establishment module 21 used for establishing the supply-side and demand-side classified water price model based on the regional comprehensive water price by using the full-cost water price theory;

a first solving module 22 used for solving the supply-side and demand-side classified water price model by adopting the cooperative game method to obtain the expected classified water prices of the supply-side and the demand-side under the preset allocation scenario of the multi-source water resources;

a calculation module 23 used for obtaining the expected comprehensive benefits and the expected regional comprehensive water prices under different allocation scenarios of the multi-source water resources by using the weighted average method according to the expected classified water prices of the supply-side and the demand-side and the water supply capacity of the multi-source water resources;

a second model establishment module 24 used for establishing the regional multi-source water resource allocation model, where the regional multi-source water resource allocation model at least meets the following constraints: the weighted average water price of the multi-source water resources for the multi-consumers is not lower than the expected regional comprehensive water price, the river and lake ecological environment control section is not worse than the target water quality, the expected comprehensive benefits of the multi-source water resource allocation are maximized, and the water availability is constrained, and the regional multi-source water resource allocation results include the water resource allocation strategy corresponding to the expected classified water prices of the supply-side and the demand-side; and

a second solving module 25 used foe solving the established regional multi-source water resource allocation model by using the cooperative game method to obtain the regional multi-source water resource allocation results.

With regard to the device in the above embodiment, a specific way in which each module performs operations has been described in detail in the embodiment of the method, and may not be described in detail here.

For the device embodiment, because it basically corresponds to the method embodiment, it is only necessary to refer to part of the description of the method embodiment for relevant points. The device embodiment described above is only schematic, in which units described as separate components may or may not be physically separated, the components displayed as units may or may not be physical units, and the components may be located in one place or distributed to multiple network units. Some or all of the modules may be selected according to actual needs to achieve the objective of the application scheme. Ordinary technicians in this field may understand and implement the modules without creative labor.

Correspondingly, the application also provides an electronic device, including one or more processors; a memory for storing one or more programs; when the one or more programs are executed by the one or more processors, the one or more processors may realize the method for the rational allocation of the regional multi-source water resources driven by the bilateral classified water prices as described above.

Correspondingly, the application also provides a computer-readable storage medium having computer instructions stored thereon, where the instructions implement the above-mentioned rational allocation method of the regional multi-source water resources driven by the bilateral classified water prices when executed by the processor.

Other embodiments of the present application may easily occur to those skilled in the art after considering the specification and practicing the disclosure herein. This application is intended to cover any variations, uses or adaptations of this application, and these variations, uses or adaptations follow general principles of this application and include common sense or common technical means in this technical field that are not disclosed in this application. The specification and embodiments are to be regarded as exemplary only, with a true scope and a spirit of the application being indicated by claims.

It should be understood that this application is not limited to the precise structure described above and shown in the drawings, and various modifications and changes may be made without departing from the scope. The scope of this application is limited only by the appended claims.

What is claimed is:

1. A method for a rational allocation of regional multi-source water resources driven by bilateral classified water prices, comprising:
establishing a supply-side and demand-side classified water price model based on a regional comprehensive water price by using a full-cost water price theory;
solving the supply-side and demand-side classified water price model by adopting a cooperative game method to obtain expected classified water prices of the supply-side and the demand-side under a preset allocation scenario of multi-source water resources;
obtaining expected comprehensive benefits and expected regional comprehensive water prices under different allocation scenarios of the multi-source water resources by using a weighted average method according to the expected classified water prices of the supply-side and the demand-side and a water supply capacity of the multi-source water resources; establishing a regional multi-source water resource allocation model, wherein the regional multi-source water resource allocation model at least meets following constraints: a weighted average water price of the multi-source water resources for the multi-consumers not lower than the expected regional comprehensive water price, a river and lake ecological environment control section not worse than a target water quality, the expected comprehensive benefits of the multi-source water resource allocation maximized, and a water availability constrained, and regional multi-source water resource allocation results comprise a water resource allocation strategy corresponding to the expected classified water prices of the supply-side and the demand-side; and
solving the established regional multi-source water resource allocation model by using the cooperative game method to obtain the regional multi-source water resource allocation results.

2. The method according to claim 1, wherein establishing the supply-side and demand-side classified water price model based on the regional comprehensive water price comprises: establishing a calculation model of the expected classified water prices of the supply-side and the demand-side for a regional multi-source water supply system with NI classes of water sources and NJ consumers and based on the regional comprehensive water price,
$$C = \frac{{\sum }_{i = 1}^{n} {Gc}_{i} \times {Q}_{i}}{{\sum }_{i = 1}^{n} {Q}_{i}} = \frac{{\sum }_{i = 1}^{n} {\sum }_{j = 1}^{m} {Gy}_{ij} \times {q}_{ij}}{{\sum }_{i = 1}^{n} {\sum }_{j = 1}^{m} {q}_{ij}} ,$$
wherein C is the regional comprehensive water price, consisting of a resource cost, an engineering cost, an environmental cost, a water supply profit rate and a tax of the regional multi-source water supply system;
Gcᵢ is an expected supply-side water price of a class i water source;
Gyᵢⱼ is a demand-side water price of the class i water source for class j consumers;
Qᵢ is a water supply quantity of the class i water source allocation under a specific water resource allocation scenario; and
qᵢⱼ is an amount of water allocated by the class i water source to the class j consumers, and
$${Q}_{i} = {\sum }_{j = 1}^{m} {q}_{ij} .$$

3. The method according to claim 1, wherein solving the supply-side and demand-side classified water price model by adopting the cooperative game method to obtain the expected classified water prices of the supply-side and the demand-side under the preset allocation scenario of the multi-source water resources comprises:
1) establishing a game strategy optimization model for supply-side multi-source water supply enterprises and demand-side consumers under a cooperative condition;
2) setting an initial value of a classified water price equilibrium point on the supply-side and the demand-side: randomly selecting the initial value of the classified water price equilibrium point from a strategy set of each decision variable as (P_{GC}⁰, P_{GY}⁰)=[(Gcᵢ⁰),(Gyᵢⱼ⁰), i=1, . . . , NI; j=1, . . . NJ];
3) making independent optimization decisions by game alliances of the supply-side and the demand-side respectively: obtaining an optimal strategy combination (P_{GC}ⁿ, P_{GY}ⁿ)=[(Gcᵢⁿ), (Gyᵢⱼⁿ), i=1, . . . , NI; j=1, . . . NJ] by each party of a game through an optimization algorithm according to an optimization result (P_{GC}ⁿ⁻¹, P_{GY}ⁿ⁻¹)=[Gcᵢⁿ⁻¹),(Gyᵢⱼⁿ⁻¹),i=1, . . . , NI; j=1, . . . NJ] of a previous round of each party during an nth round of optimization, and
$${P}_{GC}^{n} = {arg max}_{{p}_{GC}} {W}_{GC} ( {P}_{GC} , {P}_{GC}^{n - 1} ) ; {P}_{GY}^{n} = {arg min}_{{P}_{GY}} {W}_{GY} ( {P}_{GY}^{n - 1} , {P}_{GY} ) ,$$
wherein W_{GC} and W_{GY} are a revenue function of the supply-side water supply enterprises and a payment function of the demand-side consumers respectively; and
4) if two successive optimal solutions obtained by each participant in the game are the same and (P_{GC}ⁿ⁻¹, P_{GY}ⁿ⁻¹)=(P_{GC}ⁿ, P_{GY}ⁿ)=(P_{GC}^{*}, P_{GY}^{*}), considering that the game has reached a Nash equilibrium point under this strategy combination according to a Nash equilibrium definition, and ending the optimization, and obtaining expected equilibrium classified water prices of the supply-side and the demand-side under a specific allocation scenario of the multi-source water resources; otherwise, continuing the optimization.

4. The method according to claim 1, wherein obtaining the expected comprehensive benefits and the expected regional comprehensive water prices under different allocation scenarios of the multi-source water resources by using the weighted average method comprises:
obtaining the expected comprehensive benefits under different allocation scenarios of the multi-source water resources by calculating differences between expected benefits and penalty benefits of a remaining water supply capacity after the multi-source water resource allocation, wherein the penalty benefits comprise a penalty benefit caused by an unsatisfied water consumption of the demand-side consumers and a penalty benefit caused by a below-standard water quality of a river and lake control section; and
calculating a weighted average of a regional multi-source allocation water quantity and a supply-side classified water price to obtain the expected regional comprehensive water price.

5. The method according to claim 1, wherein the regional multi-source water resource allocation model is established, and the regional multi-source water resource allocation model at least meets following constraints: the weighted average water price of the multi-source water resources for the multi-consumers not lower than the expected regional comprehensive water price, the river and lake ecological environment control section not worse than the target water quality, the expected comprehensive benefits of the multi-source water resource allocation maximized, and the water availability constrained, comprising
1) an expected comprehensive benefit of the regional multi-source water resource allocation model:
$$max {F}_{Qq} = {\sum }_{i = 1}^{NI} [ {Q}_{i}^{max} - {Q}_{i} ] \times {B}_{i} - {\sum }_{i = 1}^{NI} {\sum }_{j = 1}^{NJ} [ {QE}_{ij} \times {C}_{ij} + {f}_{1} ( {q}_{ij} ) ] ;$$
2) the constraint condition that the weighted average water price of the multi-source water resources for the multi-consumers is not lower than the regional comprehensive water price:
$$\frac{{\sum }_{i = 1}^{NI} {Gc}_{i} \times {Q}_{i}}{{\sum }_{i = 1}^{NI} {Q}_{i}} = \frac{{\sum }_{i = 1}^{NI} {\sum }_{j = 1}^{NJ} {Gy}_{ij} \times {q}_{ij}}{{\sum }_{i = 1}^{NI} {\sum }_{j = 1}^{NJ} {q}_{ij}} \geq C ;$$
3) the constraint condition that the river and lake ecological environment control section not worse than the target water quality expressed as:
Qrₘ[f₂(qᵢⱼ)]≤Qrₘ^{*}; and
4) the constraint condition of the water availability expressed as:
Qᵢ≤Qᵢ^{max},
wherein F_{Qq} is the expected comprehensive benefit of the regional multi-source water resource allocation;
Qᵢ^{max} is a maximum water supply capacity of a class i water source;
Qᵢ is a water supply quantity of the class i water source allocation;
Bᵢ is a net benefit per cubic meter of water of the class i water source;
QEᵢⱼ is a water shortage allocated by the class i water source to class j consumers;
Cᵢⱼ is a penalty benefit of the water shortage per unit allocated by the class i water source to the class j consumers;
qᵢⱼ is an amount of water allocated by the class i water source to the class j consumers;
f₁(qᵢⱼ) is a penalty benefit of the river and lake ecological environment control section when the amount of water allocated by the class i water source to the class j consumers is qᵢⱼ;
Gcᵢ is a supply-side water price of the class i water source;
Gyᵢⱼ is a demand-side water price of the class i water source for the class j consumers;
C is the regional comprehensive water price;
Qrₘ└f₂(qᵢⱼ)┘ is a water quality of a mth river and lake ecological environment control section when the amount of water allocated by the class i water source to the class j consumers is qᵢⱼ; and
Qrₘ^{*} is a target water quality of the mth river and lake ecological environment control section when the amount of water allocated by the class i water source to the class j consumers is qᵢⱼ.

6. The method according to claim 1, wherein solving the established regional multi-source water resource allocation model by using the cooperative game method to obtain the regional multi-source water resource allocation results comprises:
1) establishing a game strategy optimization model of the regional multi-source water resource allocation model based on expected equilibrium classified water prices of the supply-side and the demand-side under the specific allocation scenario of the multi-source water resources;
2) setting an initial value of an equilibrium point of a multi-source water resource allocation strategy: randomly selecting the initial value of the equilibrium point of the multi-source water resource allocation strategy from a strategy set of each decision variable as Qq⁰=(qᵢⱼ⁰, i=1, . . . , NI; j=1, . . . NJ);
3) making optimization decisions by game alliances: in an nth round of optimization, obtaining an optimal strategy combination Qqⁿ=(qᵢⱼⁿ, i=1, . . . , NI; j=1, . . . NJ) through an optimization algorithm according to an optimization result of the previous round of Qqⁿ⁻¹=(qᵢⱼⁿ⁻¹, i=1, . . . , NI; j=1, . . . NJ), and
$${Qq}^{n} = {arg max}_{Qq} {F}_{Qq} ( Qq , {Qq}^{n - 1} ) ,$$
wherein F_{Qq} is an expected comprehensive benefit of the regional multi-source water resource allocation model; and
4) if two successive optimal solutions obtained by each participant in a game are the same and Qqⁿ⁻¹=Qqⁿ=Qq^{*}, considering that the game has reached a Nash equilibrium point under this strategy combination according to a Nash equilibrium definition, and ending the optimization; otherwise, continuing the optimization.

7. A rational allocation device of regional multi-source water resources driven by bilateral classified water prices, comprising:
a first model establishment module used for establishing a supply-side and demand-side classified water price model based on a regional comprehensive water price by using a full-cost water price theory;
a first solving module used for solving the supply-side and demand-side classified water price model by adopting a cooperative game method to obtain expected classified water prices of a supply-side and the demand-side under a preset allocation scenario of the multi-source water resources;
a calculation module used for obtaining expected comprehensive benefits and expected regional comprehensive water prices under different allocation scenarios of the multi-source water resources by using a weighted average method according to the expected classified water prices of the supply-side and the demand-side and a water supply capacity of the multi-source water resources;
a second model establishment module used for establishing a regional multi-source water resource allocation model, wherein the regional multi-source water resource allocation model at least meets following constraints: a weighted average water price of the multi-source water resources for multi-consumers not lower than an expected regional comprehensive water price, a river and lake ecological environment control section not worse than a target water quality, the expected comprehensive benefits of the multi-source water resource allocation maximized, and a water availability constrained, and regional multi-source water resource allocation results comprise a water resource allocation strategy corresponding to the expected classified water prices of the supply-side and the demand-side; and
a second solving module used for solving the established regional multi-source water resource allocation model by using the cooperative game method to obtain the regional multi-source water resource allocation results.

8. An electronic device, comprising:
one or more processors; and
a memory for storing one or more programs;
wherein when the one or more programs are executed by the one or more processors, the one or more processors implement a method according to claim 1.
